(19) United States
(12) Patent Application Publication
(10) Pub. No.: US 2026/0133598 A1
(43) Pub. Date: May 14, 2026

(54) TEMPERATURE CORRECTION CIRCUIT FOR A REFERENCE VOLTAGE

(71) Applicant: NXP USA, INC., AUSTIN, TX (US)

(72) Inventor: John Pigott, PHOENIX, AZ (US)

(21) Appl. No.: 18/941,509

(22) Filed: Nov. 8, 2024

(51) Int. Cl. G05F 3/18

(52) U.S. Cl. CPC G05F 3/185

(57) ABSTRACT

A temperature correction circuit for a voltage reference circuit includes two amplifiers, each having an output that controls a respective transistor that produces correction current for adjusting the reference voltage. Both amplifiers include one input coupled in a path to a reference voltage source and another input coupled in a path to a temperature sensing diode circuit. One amplifier's output controls the conductivity of its respective transistor to adjust the reference voltage when the temperature exceeds a high temperature set point. The other amplifier's output controls the conductivity of its respective transistor to adjust the reference voltage when the temperature falls below a low temperature set point.

### BACKGROUND OF THE INVENTION

### Field of the Invention

This invention relates to a temperature correction circuit for a reference voltage.

### Background

A reference voltage is used to provide a stable and predictable voltage in electronic circuits. One type of reference voltage is a bandgap voltage. A bandgap voltage is generated by a bandgap reference circuit and is based on the bandgap of semiconductor devices of the bandgap reference circuit. Another type of reference voltage is a Zener reference voltage. A Zener reference voltage is generated by a Zener reference circuit that includes Zener diode and is based on the breakdown voltage of the Zener diode.

For circuits designed to operate over wide temperature ranges, it may be desirable that a reference voltage be relatively constant over the temperature range.

### BRIEF DESCRIPTION OF THE DRAWINGS

The present invention may be better understood, and its numerous objects, features, and advantages made apparent to those skilled in the art by referencing the accompanying drawings.

FIG. 1 is a graph showing the voltage over temperature of a prior art bandgap voltage reference circuit.

FIG. 2 is a circuit diagram of a temperature correction circuit for a voltage reference circuit according to one embodiment of the present invention.

FIG. 3 is a graph showing the operation of a temperature correction circuit for a voltage reference circuit according to one embodiment of the present invention.

FIG. 4 is a circuit diagram of a temperature correction circuit for a voltage reference circuit according to one embodiment of the present invention.

FIG. 5 is a circuit diagram of a temperature correction circuit for a voltage reference circuit according to one embodiment of the present invention.

FIG. 6 is a circuit diagram of a prior art temperature correction circuit for a bandgap voltage reference circuit.

The use of the same reference symbols in different drawings indicates identical items unless otherwise noted. The Figures are not necessarily drawn to scale.

### DETAILED DESCRIPTION

The following sets forth a detailed description of a mode for carrying out the invention. The description is intended to be illustrative of the invention and should not be taken to be limiting.

As disclosed herein, a temperature correction circuit for a voltage reference circuit includes two amplifiers, each having an output that controls a respective transistor that produces correction current for adjusting the reference voltage. Both amplifiers include one input coupled in a path to a reference voltage source and another input coupled in a path to a temperature sensing diode circuit. One amplifier's output controls the conductivity of its respective transistor to adjust the reference voltage when the temperature exceeds a high temperature set point. The other amplifier's output controls the conductivity of its respective transistor to adjust the reference voltage when the temperature falls below a low temperature set point.

In some embodiments, a resistor divider is implemented in a resistive path and is used to generate temperature set point voltages that are compared with a temperature dependent voltage to generate correction currents at temperatures above a high temperature set point and below a low temperature set point.

In some embodiments providing a temperature correction circuit that utilizes two amplifiers and control transistors to provide correction currents may provide for a correction circuit that provides multi temperature segment correction of a reference voltage while utilizing lower accuracy circuits which are less susceptible to variations due to modeling deficiency, package shifts and other imperfections. In addition, the limited gain of the amplifiers may actually “round” the temperature correction to enhance performance in some embodiments. In some embodiments, such a circuit may provide up to a 9× improvement in voltage correction.

A reference voltage can be adjusted to have a negligible linear variation over temperature, but may still have a residual quadratic (parabolic) variation over temperature. This parabolic variation may be minimized by adding piecewise linear (PWL) correction that is implemented by generating a correction current dependent on the temperature deviation above a high temperature set point and a correction current dependent on the temperature deviation below a cold temperature set point. Correction current is absent in temperatures between the two set points.

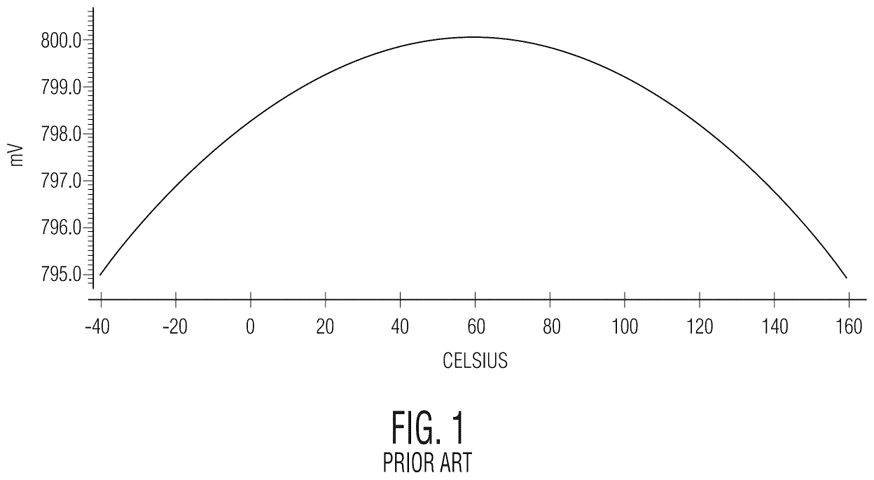

FIG. 1 is a graph showing a bandgap voltage produced by a prior art bandgap reference circuit across an operating temperature range from −40 C to 160 C. Some bandgap reference circuits are trimmed to cancel linear variation in the bandgap voltage with respect to temperature, leaving an unavoidable 2nd order variation. This 2nd order variation is shown in FIG. 1 as a parabolic variation of 5 mV over a temperature range from −40 C to 160 C, from a mid-range peak voltage of 800 mV to 795 mV at the temperature extremes. Depending upon the application, such a variation in voltage over a temperature range may be detrimental to the operation of the circuit that utilizes the bandgap voltage.

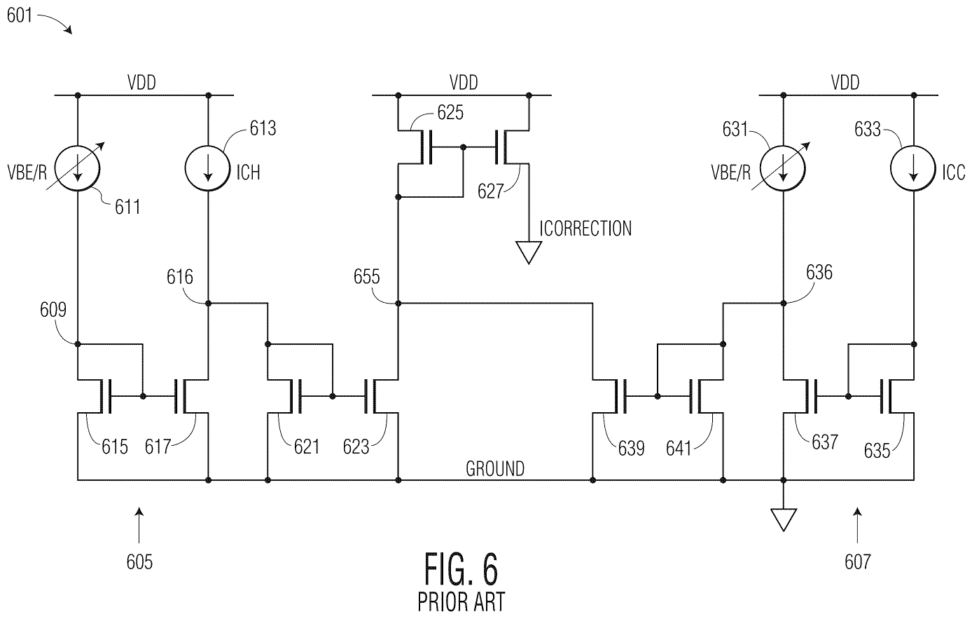

FIG. 6 is a circuit diagram of a prior art temperature compensation circuit 601 that provides a correction current (ICORRECTION) to raise the voltage of an output (not shown) of a bandgap reference circuit for segment correction when the temperature falls below a lower temperature set point or rises above a higher temperature set point to raise the bandgap voltage for these temperature ranges. Correction current ICORRECTION is produced by the current mirror of PFETs 625 and 627 when a current is produced by the current mirror of NFETs 621 and 623 in response the temperature exceeding a high temperature set point or when a current is produced by a current mirror of NFETs 639 and 641 in response to the temperature falling below a cold temperature set point.

Circuit 601 includes a current comparator 605 for determining when the temperature exceeds the high temperature set point and provides a correction current (IHOT), which is indicative of how high the temperature is above the high temperature set point. Current comparator 605 includes a temperature sensitive current source 611, a current mirror of NFETs 615 and 617, and a fixed current source 613, whose fixed current sets the high temperature set point. In FIG. 6, current source 611 represents a temperature sensing diode circuit and resistor (neither shown) that provides a current of VBE/R, which is inversely proportional to temperature.

When current VBE/R is above the fixed current ICH provided by current source 613 (indicating that the temperature is below the high temperature set point), NFET 617 is biased at a conductivity level to conduct a current that is greater than the fixed current ICH. In such a condition, the voltage of node 616 is pulled to ground such that no current flows through NFETs 621 and 623. With no current flowing through NFET 623, the current mirror of PFETs 625 and 627 will not conduct current through PFET 627, such that current ICORRECTION is at 0 Amps (assuming that NFET 639 is nonconductive as well due to the temperature being above the cold temperature set point). In such a condition, circuit 601 provides no correction current attributable to current comparator 605.

As the temperature increases, current VBE/R decreases to decrease the conductivity of NFET 617. When the conductivity of NFET 617 decreases to where it will no longer conduct all of the fixed current ICH, then the voltage of node 616 will rise and NFETs 621 and 623 will become conductive. With NFET 623 being conductive, the current mirror of PFETs 625 and 627 will cause ICORRECTION to rise above 0 AMPs. With VBE/R<ICH, the current through NFET 621 (IHOT) will be equal to IC-VBE/R and will increase proportionally to the increase in temperature above the temperature set point as set by fixed current ICH. ICORRECTION current will increase proportionally as well. Because current ICORRECTION is provided to a bandgap reference circuit (not shown), it increases the voltage of the bandgap voltage proportional to its increase in current.

Circuit 601 includes a current comparator 607 for determining when the temperature falls below the low temperature set point and provides a correction current, which is indicative of how much the temperature is below the low temperature set point. Current comparator 607 includes a temperature sensitive current source 631, a current mirror of NFETs 635 and 637, and a fixed current source 633 whose fixed current sets the low temperature set point. In FIG. 6, current source 631 represents a temperature sensing diode circuit and resistor (neither shown) that provides a current of VBE/R, which is inversely proportional to temperature.

When the fixed current ICC is above current VBE/R provided by current source 631 (indicating that the temperature is above the low temperature set point), NFET 637 is biased at a conductivity level to conduct a current that is greater than current VBE/R provided by current source 631. In such a condition, the voltage of node 636 is pulled to ground such that no current flows through NFETs 639 and 641. With no current flowing through NFET 639, the current mirror of PFETs 625 and 627 will not conduct current through PFET 627, such that ICORRECTION is at 0 Amps (assuming that NFET 623 is nonconductive as well due to the temperature being below the high temperature set point). In such a condition, circuit 601 provides no correction current attributable to current comparator 607.

As the temperature decreases, current VBE/R increases to where it provides more current than NFET 637 is able to conduct, since the conductivity of NFET 637 is set by fixed current ICC. When current source 631 produces more current than NFET 637 is able to conduct, the voltage of node 636 rises to where NFETs 639 and 641 become conductive. With NFET 639 being conductive, the current mirror of PFETs 625 and 627 will cause ICORRECTION to rise above 0 AMPs. With VBE/R(from current source 631) >ICC, the current through NFET 641 will be equal to VBE/R-ICC and will increase inversely proportional to the decrease in temperature below the low temperature set point as set by fixed current ICC. ICORRECTION current will increase inversely proportional as well to adjust the bandgap voltage. Because current ICORRECTION is provided to a bandgap reference circuit (not shown) and increases the voltage of the bandgap voltage proportional to its increase in current, the amount of voltage compensation to a bandgap voltage will change inversely proportional with temperature when VBE/R(from current source 631)>ICC.

One issue is that circuit 601 uses currents ICC and ICH to set the temperature set points, which may lead to accuracy issues, and which may consume a relatively large amount of current. It also uses a current mirror of PFETs 625 and 627 which may conduct very small currents and which may cause accuracy issues as well.

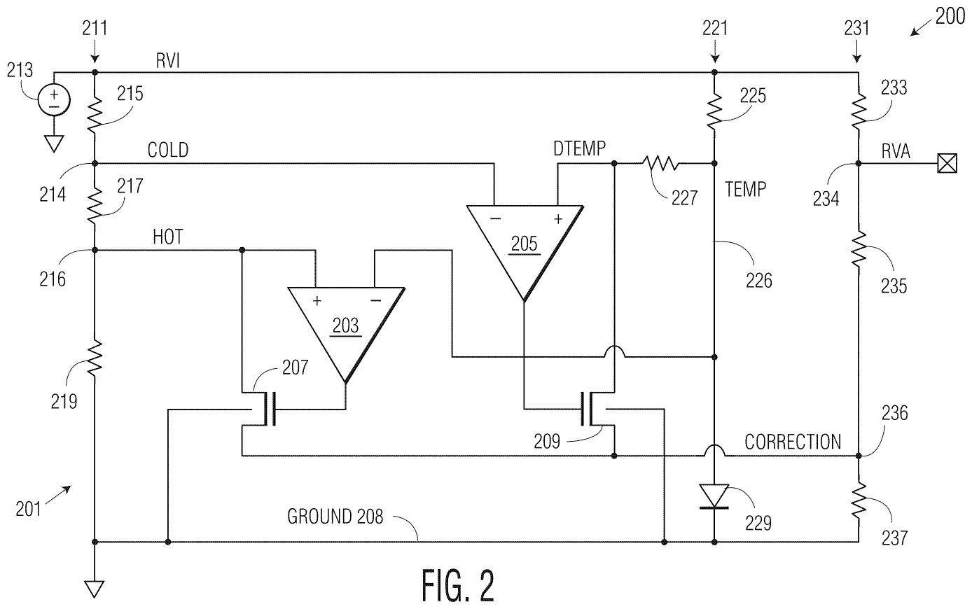

FIG. 2 shows a temperature correction circuit 201 for a bandgap voltage reference circuit 200 according to one embodiment of the present invention. Circuit 200 includes a bandgap voltage source 213 that includes an output terminal that provides a bandgap voltage RVI. Bandgap voltage source 213 generates a bandgap voltage (RVI) based on the bandgap of the semiconductor devices (not shown) of bandgap voltage source 213. In one embodiment, an undivided bandgap voltage produced by voltage source 213 is typically 1.23V, but may be of other voltages in other embodiments. An output current path 231 is coupled to the output terminal of voltage source 213 and includes resistors 233, 235, and 237 to produce a bandgap voltage (RVA) at a node 234 of path 231 that is divided down to a desired value (e.g., 0.8V) that is useful to a system utilizing the bandgap voltage. The bandgap voltage (RVA) of node 234 can be adjusted by reference circuit 200 to compensate for temperature variation.

Circuit 201 includes a resistive current path 211 connected to the output of voltage source 213. Path 211 includes resistors 215, 217, and 219. Resistor 219 is connected to power supply rail 208, which in the embodiment shown, is biased at a ground supply voltage, but may be biased at other supply voltages in other embodiments.

Circuit 201 includes a biasing path 221 connected to the output of bandgap voltage source 213. Path 221 includes a resistor 225 and a diode 229. The voltage across diode 229 (the voltage at node 226 labeled TEMP) is the forward bias voltage of diode 229 which varies inversely with temperature. In some embodiments, the voltage across diode 229 varies at approximately −2 mV/C, but may vary at other rates in other embodiments.

Circuit 201 includes operational amplifier 203 that includes a noninverting input connected to node 216 of path 211 and an inverting input connected to a terminal of diode 229 at node 226. The output of amplifier 203 is connected to the gate of NFET 207. The drain of NFET 207 is connected to the noninverting input of amplifier 203 and to node 216 of path 211. The source of NFET 207 is connected to node 236 of path 231. The body bias terminal of NFET 207 is connected to rail 208. However, in other embodiments, the body bias terminal may be connected to node 236.

Circuit 201 includes operational amplifier 205 that includes an inverting input connected to node 214 of path 211 and a noninverting input connected to a terminal of resistor 227. The other terminal of resistor 227 is connected to node 226. The output of amplifier 205 is connected to the gate of NFET 209. The drain of NFET 209 is connected to the noninverting input of amplifier 205 and to resistor 227. The source of NFET 207 is connected to node 236 of path 231. The body bias terminal of NFET 209 is connected to ground rail 208, but may be connected to node 236 in other embodiments.

In one embodiment, resistors 215, 217, 219, 227, 225, 233, 235, and 237 have a resistance of 100K, 200K, 400K, 240K, 600K, 403K, 750K, and 50K, respectively. Bandgap voltage source 213 is designed to provide a maximum bandgap voltage of 1.23 V and path 231 is designed to provide a bandgap voltage RVA of approximately 800 mV at node 234. However, these voltages and resistances may be of different values in other embodiments.

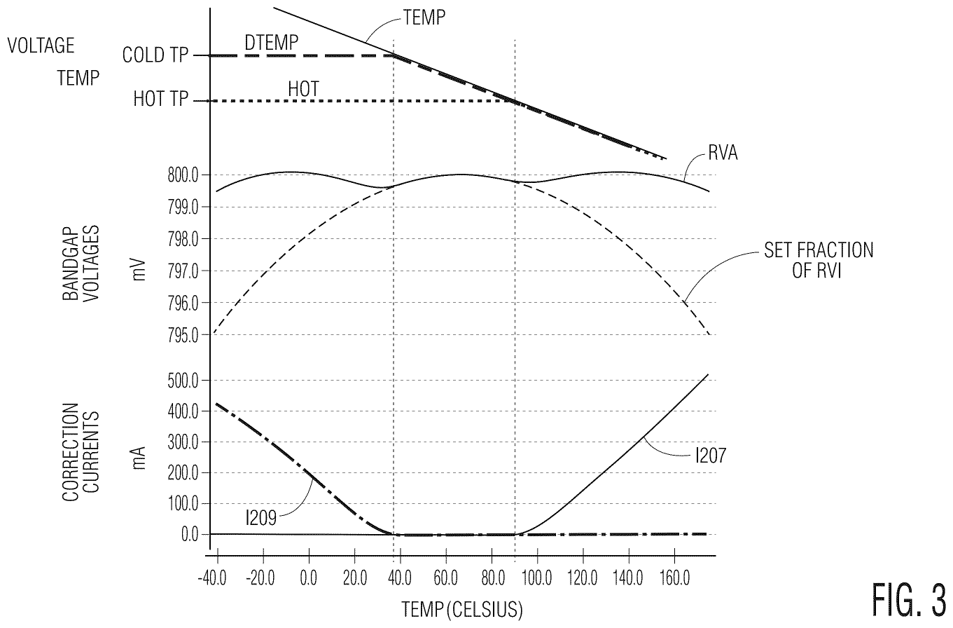

FIG. 3 is a graph showing the operation of circuit 200 across a temperature range of −40 C to 170 C. The operation the circuit of FIG. 2 will be described with reference to the voltages and currents of the graph of FIG. 3. As shown in FIG. 3, the voltage across diode 229 at node 226 (labeled TEMP in FIG. 3) is generally linear and inversely proportional to temperature.

During operation when the temperature is in a mid-temperature range (e.g., approximately 38-90 C), the voltage of bandgap voltage source 213 (labeled RVI in FIG. 2) is near its maximum value (e.g., 1.23 V) . FIG. 3 shows a voltage that is a set fraction (e.g., approximately ⅔) of voltage RVI (labeled in FIG. 3 as SET FRACTION OF RVI). The set fraction is determined by the ratio of the sum of resistance of resistors 235 and 237 to the total of resistors 233, 235 and 237, which in one embodiment is slightly less than two thirds. In this temperature range, the voltage of the output of circuit 200 (RVA) is approximately equal to the set fraction of RVI in that circuit 200 provides no correction current across resistor 237 from either NFET 207 or NFET 209. However, in other embodiments, RVA may be of another fraction of RVI in the mid temperature range.

Referring back to FIG. 2, when the temperature is in this midrange, node 216 is at a voltage (HOT TP on the graph of FIG. 3) indicative of a hot temperature set point and node 216 is at a voltage (COLD TB) indicative of a low temperature set point with respect to the voltage of node 226. These voltage set points (HOT TP and COLD TP) are indicative of the temperatures at which temperature correction circuit 201 begins to adjust voltage RVA as the temperature rises above the temperature indicated by HOT TP or falls below the temperature indicated by COLD TP.

When the temperature is in the midrange (or lower), the voltage of node 226 (labeled TEMP) is above the voltage of node 216 (HOT in FIGS. 2 and 3). In this condition, the voltage of the output of amplifier 203 is driven to a low voltage value such that NFET 207 is nonconductive and no correction current is being provided.

As the temperature climbs above the temperature indicated by HOT TP, the voltage of node 226 (TEMP) becomes lower than the voltage of node 216. Because amplifier 203 is in a closed-loop, feedback configuration, amplifier 203 drives the gate voltage of NFET 207 at voltage where NFET 207 begins to conduct to lower the voltage of node 216 (HOT) to match the voltage of node 226 (TEMP). When NFET 207 is conductive, it provide a correction current (labeled I207 in FIG. 3) to resistor 237 that raises the voltage drop across resistor 237 to raise the voltage of RVA to compensate for the decrease in the voltage of RVI due to the increase in temperature. See FIG. 3 where it shows the voltage of the SET FRACTION OF RVI drops as the temperature rises above 90 C. The greater the increase in temperature, the higher the voltage of the output of amplifier 203 to make NFET 207 conductive to lower HOT to match TEMP to where more correction current is being supplied to resistor 237 to raise the voltage of RVA to compensate for the drop of RVI at these temperatures. Accordingly, the amount of correction current from NFET 207 (I207 in FIG. 3) increases proportionally with the increase in temperature in this temperature range. Correspondingly, the amount of voltage correction increases proportionally to the increase in temperature as well. However, in some embodiments, the change in correction current produced by NFET 207 would not necessarily be proportional to the change in temperature when the temperature is above the temperature indicated by HOT TP, but would still be positively correlated with the change in temperature to effectively adjust the bandgap voltage within a tolerance over the upper portion of the temperature range. If a change in one characteristic is proportional to a change in another characteristic, it is also positively correlated with a change in the another characteristic.

When the temperature is above the cold temperature set point indicated by the voltage of node 214 (COLD TP), the voltage of TEMP is below the voltage of node 214 (COLD). At this point, the voltage of the output of amplifier 205 is low in that the inverting input of amplifier 205 is at a higher voltage than the noninverting input. Therefore, NFET 209 is nonconductive, and no correction current is being provided at the source of NFET 209. Also at this time, since NFET 209 is nonconductive, there is no current through resistor 227 and the voltage of DTEMP is approximately equal to the voltage of node 226 (TEMP).

However, once the temperature falls below the temperature indicated by the cold set point voltage of node 214 (COLD TP), the voltage of node 226 (TEMP) and voltage DTEMP rise above the voltage COLD. Because amplifier 205 is in a closed-loop, feedback configuration, the voltage of the output of amplifier 205 rises to cause NFET 209 to become conductive to pull the voltage of DTEMP to match the voltage of COLD (and pull the voltage of DTEMP away from the voltage of TEMP). The further that the temperature drops below the cold temperature set point indicated the voltage of node 214 (COLD), the higher the voltage of the output of amplifier 205 to make NFET 209 more conducive, and the greater the amount of correction current through resistor 237 (labeled I209 in FIG. 3) to raise the voltage of RVA compensate for the drop in RVI in this temperature range. In some embodiments, when the temperature is below the temperature set point of COLD TP, current (I209) provided by NFET 209 changes proportional to the negative change in temperature. Accordingly, in such a condition, the amount of voltage adjustment provided by the current from NFET 209 is proportional to the negative change in temperature in this temperature range. In some embodiments, the change in the amount of correction current produced by NFET 209 would not necessarily be proportional to the negative change in temperature, but would still be correlated with the negative change in temperature to effectively adjust the bandgap voltage within a tolerance within this temperature range. If a change in one characteristic is proportional to a negative change in another characteristic, it is also correlated with a negative change in that characteristic.

Accordingly, circuit 201 provides a correction current that raises the bandgap voltage RVA for temperatures below a cold set point and for temperatures above a hot set point to compensate for the decrease in voltage of RVI due to operating in either of those edge temperature ranges. Accordingly, the voltage variation of RVA can remain relatively flat over a larger temperature range. As shown in the embodiment of FIG. 3, the voltage of RVA only varies by less than 1 mV over a range in temperatures from −40 C to 160 C.

The degree of voltage compensation of the bandgap voltage with respect to the correction current (CORRECTION) can be adjusted by adjusting the resistances of the resistors of current path 231. In some embodiments, the relative strength of the correction at temperatures above the hot set point and below the cold set point can be adjusted by changing the resistance of resistor 227 with respect the resistances of resistor 215, 217, and 219.

Also as shown above, the actions of amplifier 203 and NFET 207 in providing a voltage adjustment during hot temperatures and the actions of amplifier 205 and NFET 209 in providing a voltage adjustment during cold temperatures are both unidirectional in that they only sink current when the temperature is above the hot set point (for amplifier 203) or below the cold set point (for amplifier 205).

Furthermore, in some embodiments, the limited gain of operational amplifiers 203 and 205 may “round” the temperature correction to enhance performance. In some embodiments, when the temperature crosses a set point, a correction current is not immediately generated because it takes a small error voltage differential to make NFET 207 and 209 conductive. The net effect is that the start of the correction current is not abrupt, but is smoother. This may reduce variations in the reference voltage around the temperature set points. Furthermore, in some embodiments, the amplifiers may be designed to further limit the gain to implement this feature more effectively.

In some embodiment, the resistors shown in FIG. 2 have a similar temperature characteristic to the resistors in the bandgap voltage source 213, which aids in making the correction current proportional or nearly proportional to the temperature deviation outside of the midrange temperatures.

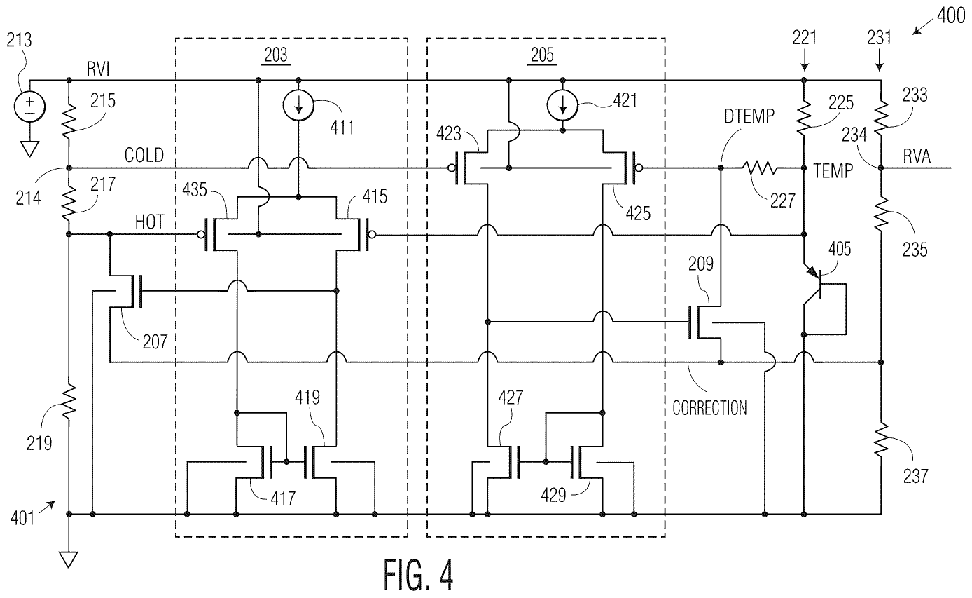

FIG. 4 shows a circuit diagram of a temperature correction circuit 401 for a reference circuit 400 according to another embodiment. The items having the same reference numbers as the circuit of FIG. 2 are similar.

FIG. 4 shows more details on the implementation of operational amplifiers 203 and 205 according to one embodiment. In FIG. 4, amplifier 203 is implemented with a current source 411 and PFETs 413 and 415, wherein the non inverting input of amplifier 203 is connected to the gate of PFET 413 and the inverting input is connected to the gate of PFET 415. The body region terminals of PFETs 413 and 415 are connected to the output (RVI) of bandgap voltage source 213. Amplifier 203 also includes a current mirror of NFETs 417 and 419, whose body region terminals and sources are connected to ground.

In FIG. 4, amplifier 205 is implemented with a current source 421 and PFETs 423 and 425, wherein the non inverting input of amplifier 205 is connected to the gate of PFET 425 and the inverting input is connected to the gate of PFET 423. The body region terminals of PFETs 423 and 425 are connected to the output (RVI) of bandgap voltage source 213. Amplifier 205 also includes a current mirror of NFETs 427 and 429, whose body region terminals and sources are connected to ground.

Also in FIG. 4, the diode temperature sensing circuit is implemented with a PNP transistor 405 in a diode configuration where its base is connected to its collector. In other embodiments, other types of diode temperature sensing circuits may be used such as a NPN transistor in a diode configuration. Also, other embodiments may be implemented with other types of amplifiers.

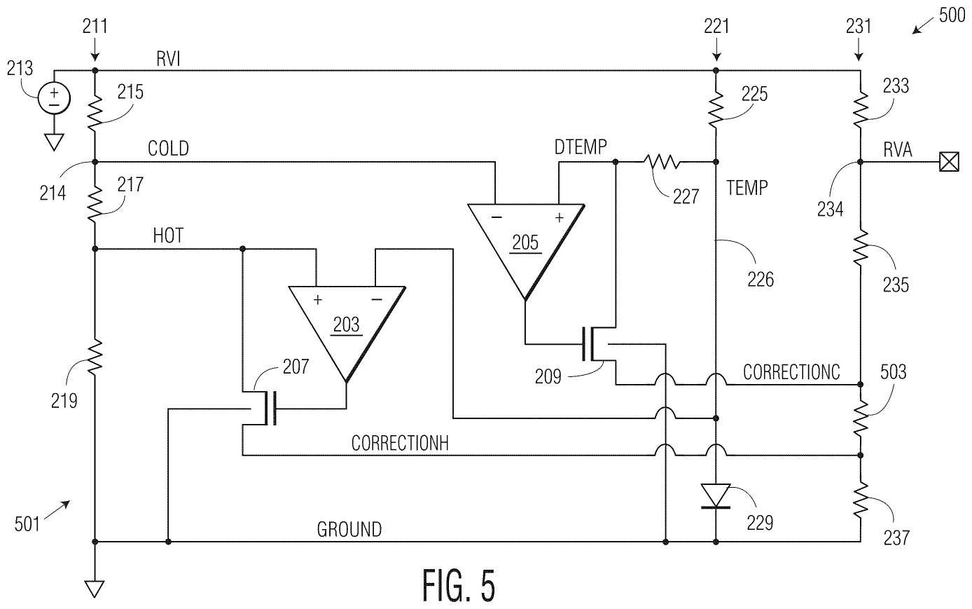

FIG. 5 shows a circuit diagram of a temperature correction circuit 501 for a voltage reference circuit 500 according to another embodiment. The items having the same reference numbers as to the circuit of FIG. 2 are similar. Voltage reference circuit 500 is characterized as a Zener reference circuit in that the reference voltage source 513 is a Zener diode voltage source that includes Zener diode (not shown) and is based on the breakdown voltage of the Zener diode. In one embodiment, the breakdown voltage of a Zener diode is 5.1 volts, but may be of other voltages in other embodiments.

In the embodiment of FIG. 5, the correction current from amplifier NFET 209 (CORRECTIONC) is provided to a terminal of resistor 503 such that correction current CORRECTIONC flows through resistor 503 and resistor 237. In contrast, the correction current from NFET 207 only flows through resistor 237.

Accordingly, because correction current CORRECTIONC flows through a greater resistance (resistors 503 and 237) than correction current CORRECTIONH (resistor 237 only), current CORRECTIONC will provide a greater voltage correction to RVA than current CORRECTIONH. Such a configuration may be used where the output voltage of Zener voltage source 513 changes at a greater rate with respect to a change in temperature in the colder temperature ranges than in the hotter temperature ranges. The amount of adjustment to RVA by CORRECTIONC and CORRECTIONH can be individually tailored by setting the resistances of resistors 235, 503, and 237.

In other embodiments where the voltage of the output of voltage source 513 changes at a greater rate with respect to a change in temperature in the higher temperature range than in the lower temperature range, CORRECTIONH can be provided across resistors 503 and 537 and CORRECTIONC can be provided across only resistor 237.

The temperature adjustment circuits described herein may have other modifications in other embodiments. For example, although the embodiments of FIGS. 2, 4, and 5 show that the current from NFETs 207 and 209 are applied to resistor 237, in other embodiments, the currents from NFETs 207 and 209 may be applied to a current mirror that produces a mirrored current in path 231 to adjust the voltage of RVA. Also, other types of transistors may be used (e.g., PFETs, bipolar transistors), and other types of resistive circuits may be used.

In other embodiments, the temperature set points can be designed to be at different values by changing the resistance values of the resistors of path 211. For example, in some embodiments, the cold and hot set points can be set at 33 percent and 67 percent of the temperature range. Thus, for a range of −40 C to 175 C, the cold set point would be at 32 C and the hot set point would be 103 C. However, the set points may be at other values in other embodiments including at other percentages. In some embodiments where the temperature set points are at 33 and 67 percent of the temperature range, a 9× reduction in parabolic variation may be achieved.

In some of the embodiments, at least some of the resistive circuits may be programmable (e.g., resistors 215, 217, 233, 237) to program the temperature set points or the value of RVA versus the maximum value of RVI.

One advantage of at least some embodiments of the temperature correction circuits described herein is that the correction voltages generated by the temperature correction circuits are not significantly dependent on process parameters nor require high-precision circuits for generation. Also, the temperature correction circuits of FIGS. 2, 4, and 5 include only one temperature sensing diode circuit for determining both the hot and cold temperature set points, which reduces the number devices in a circuit and the amount of current consumed.

Although the temperature correction circuits 201 and 401 are shown and described as being used in a bandgap reference circuit and the temperature correction circuit 501 is shown as being used in a Zener correction circuit, the temperature correction circuits described herein can be used with either a Zener voltage source, a bandgap voltage source, or another type of reference voltage source.

The temperature adjustment circuits shown and described herein may be used in any one of a number of systems such as e.g., computers, cell phones, automotive electronics, wearables, IOT systems, industrial control equipment, embedded systems, or communications equipment.

As used herein, one item is “coupled” to another item in a path either by being connected to the other item or by being coupled in a current path through at least one further item. For example, in FIG. 2, the drain of NFET 207 is coupled to the output of voltage source 213 through resistors 217 and 215. The drain of NFET 207 is coupled to node 216 by being connected to it. A gate is a control terminal of a FET. A drain and source are current terminals of a FET.

Features specifically shown or described with respect to one embodiment set forth herein may be implemented in other embodiments set forth herein.

In one embodiment, a circuit includes a reference voltage source, an output coupled to the reference voltage source, the output for providing a reference voltage, a temperature sensing diode circuit, a first amplifier having a first input coupled in a path to the reference voltage source and a second input coupled in a path to a terminal of the temperature sensing diode circuit, a first transistor including a control terminal coupled to an output of the first amplifier and a first current terminal to provide a correction current for adjusting the reference voltage in response to the temperature sensing diode circuit indicating that a first temperature is being exceeded, a second amplifier including a first input coupled in a path to the reference voltage source and a second input coupled in a path to the terminal of the temperature sensing diode circuit, and a second transistor including a control terminal coupled to an output of the second amplifier and a first current terminal for providing a correction current for adjusting the reference voltage in response to the temperature sensing diode circuit indicating that the temperature is below a second temperature.

In a further embodiment, a second current terminal of the first amplifier is coupled to the first input of the first amplifier.

In a further embodiment, when the temperature sensing diode circuit indicates that the first temperature is being exceeded, the first amplifier drives its output at a voltage to control the conductivity of the first transistor such that the voltage of the first input of the first amplifier matches the voltage of the second input of the first amplifier.

In a further embodiment, the first current terminal of the first transistor provides no correction current for adjusting the reference voltage when the temperature sensing diode circuit indicates that the first temperature is not being exceeded.

In a further embodiment, the first amplifier controls the amount of correction current produced by the first current terminal of the first transistor such that a change the amount of the correction current has a positive correlation with a change in temperature when the first temperature is being exceeded.

In a further embodiment, a second current terminal of the second transistor is coupled to the second input of the second transistor.

In a further embodiment, when the temperature sensing diode circuit indicates that the temperature is below the second temperature, the second amplifier drives its output at a voltage to control the conductivity of the second transistor such that the voltage of the second input of the second amplifier matches the voltage of the first input of the second amplifier.

In a further embodiment, the first current terminal of the second transistor provides no correction current for adjusting the reference voltage in response to the temperature sensing diode circuit indicating that the temperature is not below the second temperature.

In a further embodiment, the second amplifier controls the amount of correction current produced by the first current terminal of the second transistor such that a change in the amount of correction current has a positive correlation with a negative change in temperature when the temperature is below the second temperature.

In a further embodiment, the output is provided by a node in an output current path, wherein the correction current provided by the first current terminal of the first amplifier and the correction current provided by the first current terminal of the second amplifier are provided across a resistive circuit of the output current path to adjust the reference voltage.

In a further embodiment, the circuit includes a resistive path, from the reference voltage source to a power supply rail, wherein the first input of the first amplifier is coupled to a first node of the resistive path and the first input of the second amplifier is coupled to a second node of the resistive path, wherein a resistive circuit is located in the resistive path between the first node and the second node.

In a further embodiment, the terminal of the temperature sensing diode circuit is coupled to the reference voltage source through a biasing current path.

In a further embodiment, the second input of the second amplifier is coupled to a node of the biasing current path through at least one resistive circuit.

In a further embodiment, the reference voltage source is characterized as a bandgap voltage source and the reference voltage is characterized as a bandgap reference voltage.

In a further embodiment, the reference voltage source is characterized as a Zener voltage source and the reference voltage is characterized as a Zener reference voltage.

In a further embodiment, the output is coupled to the reference voltage source through at least one resistive circuit.

In a further embodiment, the temperature sensing diode circuit includes a bipolar transistor with its base connected to its collector.

In a further embodiment, the first current terminal of the first transistor and the first current terminal of the second transistor are connected together.

In a further embodiment, at least one resistive circuit 503 is located in path between the first current terminal of the first transistor and the first current terminal of the second transistor.

In a further embodiment, the output is connected to a node of a current path from the reference voltage source to a power supply rail wherein the correction current from the first current terminal of the first transistor and the correction current from the first current terminal from the second transistor are each provided through a resistive circuit located in the current path between the power supply rail and the node of the path.

In another embodiment, a circuit includes a reference voltage source, an output path from the reference voltage source to a power supply rail, an output connected to a node of the output path for providing a reference voltage, a temperature sensing diode circuit, a first amplifier having a first input coupled in a path to the reference voltage source and a second input coupled in a path to a terminal of the temperature sensing diode circuit, a first transistor including a control terminal coupled to an output of the first amplifier and a first current terminal to provide a correction current for adjusting the reference voltage in response to the temperature sensing diode circuit indicating that a first temperature is being exceeded, a second amplifier including a first input coupled in a path to the reference voltage source and a second input coupled in a path to the terminal of the temperature sensing diode circuit, and a second transistor including a control terminal coupled to an output of the second amplifier and a first current terminal for providing a correction current for adjusting the reference voltage in response to the temperature sensing diode circuit indicating that the temperature is below a second temperature. A second current terminal of the first amplifier is coupled to the first input of the first amplifier, and a second current terminal of the second transistor is coupled to the second input of the second transistor.

In a further embodiment, the output path includes a resistive circuit coupled in the path between the node and the power supply rail, wherein the correction current from the first current terminal of the first transistor for adjusting the reference voltage in response to the temperature sensing diode circuit indicating that the first temperature is being exceeded flows through the resistive circuit to adjust the reference voltage, and the correction current from the first current terminal of the second transistor for adjusting the reference voltage in response to the temperature sensing diode circuit indicating that the temperature is below the second temperature flows through the resistive circuit to adjust the reference voltage.

In a further embodiment, when the temperature sensing diode circuit indicates that a first temperature is being exceeded, the first amplifier drives its output at a voltage to control the conductivity of the first transistor such that the voltage of the first input of the first amplifier matches the voltage of the second input of the first amplifier, and when the temperature sensing diode circuit indicates that the temperature is below a second temperature, the second amplifier drives its output at a voltage to control the conductivity of the second transistor such that the voltage of the second input of the second amplifier matches the voltage of the first input of the second amplifier.

In a further embodiment, the first current terminal of the first transistor provides no correction current for adjusting the reference voltage when the temperature sensing diode circuit indicates that the first temperature is not being exceeded, and the first current terminal of the second transistor provides no correction current for adjusting the reference voltage in response to the temperature sensing diode circuit indicating that the temperature is not below the second temperature.

While particular embodiments of the present invention have been shown and described, it will be recognized to those skilled in the art that, based upon the teachings herein, further changes and modifications may be made without departing from this invention and its broader aspects, and thus, the appended claims are to encompass within their scope all such changes and modifications as are within the true spirit and scope of this invention.

What is claimed is:

1. A circuit, comprising:
a reference voltage source;
an output coupled to the reference voltage source, the output for providing a reference voltage;
a temperature sensing diode circuit;
a first amplifier having a first input coupled in a path to the reference voltage source and a second input coupled in a path to a terminal of the temperature sensing diode circuit;
a first transistor including a control terminal coupled to an output of the first amplifier and a first current terminal to provide a correction current for adjusting the reference voltage in response to the temperature sensing diode circuit indicating that a first temperature is being exceeded;
a second amplifier including a first input coupled in a path to the reference voltage source and a second input coupled in a path to the terminal of the temperature sensing diode circuit;
a second transistor including a control terminal coupled to an output of the second amplifier and a first current terminal for providing a correction current for adjusting the reference voltage in response to the temperature sensing diode circuit indicating that the temperature is below a second temperature.

2. The circuit of claim 1 wherein a second current terminal of the first amplifier is coupled to the first input of the first amplifier.

3. The circuit of claim 2 wherein when the temperature sensing diode circuit indicates that the first temperature is being exceeded, the first amplifier drives its output at a voltage to control the conductivity of the first transistor such that the voltage of the first input of the first amplifier matches the voltage of the second input of the first amplifier.

4. The circuit of claim 1 wherein the first current terminal of the first transistor provides no correction current for adjusting the reference voltage when the temperature sensing diode circuit indicates that the first temperature is not being exceeded.

5. The circuit of claim 1 wherein the first amplifier controls the amount of correction current produced by the first current terminal of the first transistor such that a change the amount of the correction current has a positive correlation with a change in temperature when the first temperature is being exceeded.

6. The circuit of claim 1 wherein a second current terminal of the second transistor is coupled to the second input of the second transistor.

7. The circuit of claim 6 wherein when the temperature sensing diode circuit indicates that the temperature is below the second temperature, the second amplifier drives its output at a voltage to control the conductivity of the second transistor such that the voltage of the second input of the second amplifier matches the voltage of the first input of the second amplifier.

8. The circuit of claim 1 wherein the first current terminal of the second transistor provides no correction current for adjusting the reference voltage in response to the temperature sensing diode circuit indicating that the temperature is not below the second temperature.

9. The circuit of claim 1 wherein the second amplifier controls the amount of correction current produced by the first current terminal of the second transistor such that a change in the amount of correction current has a positive correlation with a negative change in temperature when the temperature is below the second temperature.

10. The circuit of claim 1 wherein the output is provided by a node in an output current path, wherein the correction current provided by the first current terminal of the first amplifier and the correction current provided by the first current terminal of the second amplifier are provided across a resistive circuit of the output current path to adjust the reference voltage.

11. The circuit of claim 1 further comprising a resistive path, from the reference voltage source to a power supply rail, wherein the first input of the first amplifier is coupled to a first node of the resistive path and the first input of the second amplifier is coupled to a second node of the resistive path, wherein a resistive circuit is located in the resistive path between the first node and the second node.

12. The circuit of claim 1 wherein the terminal of the temperature sensing diode circuit is coupled to the reference voltage source through a biasing current path.

13. The circuit of claim 12 wherein the second input of the second amplifier is coupled to a node of the biasing current path through at least one resistive circuit.

14. The circuit of claim 1 wherein the reference voltage source is characterized as a bandgap voltage source and the reference voltage is characterized as a bandgap reference voltage.

15. The circuit of claim 1 wherein the reference voltage source is characterized as a Zener voltage source and the reference voltage is characterized as a Zener reference voltage.

16. The circuit of claim 1 wherein the output is coupled to the reference voltage source through at least one resistive circuit.

17. The circuit of claim 1 wherein the temperature sensing diode circuit includes a bipolar transistor with its base connected to its collector.

18. The circuit of claim 1 wherein the first current terminal of the first transistor and the first current terminal of the second transistor are connected together.

19. The circuit of claim 1 wherein at least one resistive circuit 503 is located in path between the first current terminal of the first transistor and the first current terminal of the second transistor.

20. The circuit of claim 1 wherein the output is connected to a node of a current path from the reference voltage source to a power supply rail wherein the correction current from the first current terminal of the first transistor and the correction current from the first current terminal from the second transistor are each provided through a resistive circuit located in the current path between the power supply rail and the node of the path.

21. A circuit, comprising:
a reference voltage source;
an output path from the reference voltage source to a power supply rail;
an output connected to a node of the output path for providing a reference voltage;
a temperature sensing diode circuit;
a first amplifier having a first input coupled in a path to the reference voltage source and a second input coupled in a path to a terminal of the temperature sensing diode circuit;
a first transistor including a control terminal coupled to an output of the first amplifier and a first current terminal to provide a correction current for adjusting the reference voltage in response to the temperature sensing diode circuit indicating that a first temperature is being exceeded;
a second amplifier including a first input coupled in a path to the reference voltage source and a second input coupled in a path to the terminal of the temperature sensing diode circuit;
a second transistor including a control terminal coupled to an output of the second amplifier and a first current terminal for providing a correction current for adjusting the reference voltage in response to the temperature sensing diode circuit indicating that the temperature is below a second temperature;
wherein a second current terminal of the first amplifier is coupled to the first input of the first amplifier;
wherein a second current terminal of the second transistor is coupled to the second input of the second transistor.

22. The circuit of claim 21 wherein:
the output path includes a resistive circuit coupled in the path between the node and the power supply rail, wherein the correction current from the first current terminal of the first transistor for adjusting the reference voltage in response to the temperature sensing diode circuit indicating that the first temperature is being exceeded flows through the resistive circuit to adjust the reference voltage;
the correction current from the first current terminal of the second transistor for adjusting the reference voltage in response to the temperature sensing diode circuit indicating that the temperature is below the second temperature flows through the resistive circuit to adjust the reference voltage.

23. The circuit of claim 21 wherein:
when the temperature sensing diode circuit indicates that a first temperature is being exceeded, the first amplifier drives its output at a voltage to control the conductivity of the first transistor such that the voltage of the first input of the first amplifier matches the voltage of the second input of the first amplifier;
when the temperature sensing diode circuit indicates that the temperature is below a second temperature, the second amplifier drives its output at a voltage to control the conductivity of the second transistor such that the voltage of the second input of the second amplifier matches the voltage of the first input of the second amplifier.

24. The circuit of claim 21 wherein:
the first current terminal of the first transistor provides no correction current for adjusting the reference voltage when the temperature sensing diode circuit indicates that the first temperature is not being exceeded;
the first current terminal of the second transistor provides no correction current for adjusting the reference voltage in response to the temperature sensing diode circuit indicating that the temperature is not below the second temperature.
